(19) United States
(12) Patent Application Publication
(10) Pub. No.: US 2008/0047933 A1
(43) Pub. Date: Feb. 28, 2008

(54) Method For Machining A Material With High-Power Density Electromagnetic Radiation

(76) Inventors: Antti Salminen, Lappeenranta (FI); Jari Hovikorpi, Kotka (FI)

Correspondence Address: JOEL D. SKINNER, JR.;SKINNER AND ASSOCIATES, 212 COMMERCIAL ST., HUDSON, WI, 54016, US

(21) Appl. No.: 10/592,596

(22) PCT Filed: Mar. 16, 2005
(86) PCT No.: PCT/FI05/50087

§ 371 Date: Aug. 27, 2007

(30) Foreign Application Priority Data
Mar. 18, 2004 (FI) 20045084

(51) Int. Cl. C03C 15/00

(52) U.S. Cl. 216/65

(57) ABSTRACT

The invention relates to a method for machining a material with high-power density electromagnetic radiation. The radiation has its wavelength selected material-specifically, such that the radiation penetrates inside the material without substantial surface absorption. The radiation is focused on a spot inside the material and/or in the proximity of a penetration surface and this spot is moved along a desired machining path. The electromagnetic radiation can be provided by laser light and the focusing can be effected by means of optics. The method is particularly useful in cutting glass and the method offers benefits, including only slight heating of the machined workpiece, smoothness of the fracture plane and no vaporization of harmful alloying elements.

The invention relates to method for machining a material with high-power density electromagnetic radiation.

The first already tested operations for a method of the invention include various glass cutting applications by means of a working laser. The use of laser has already been practiced earlier, e.g. for glass cutting, but the prior known methods are based on the surface absorption of glass, i.e. energy absorbs in the surface layer, heats it up and leads to the melting and vaporization of glass. Accordingly, the material breaks up by virtue of a thermal shock created in glass. Other problems include uncontrolled break-up of material and difficulties in thickness control. It is an object of the invention to provide an improved machining method which offers benefits over prior art methods, including only slight heating of the workpiece, smoothness of the fracture plane (e.g. in glass) and no vaporization of harmful alloying elements.

This object is accomplished by the invention on the basis of characterizing features as defined in the appended claim 1.

Preferred embodiments of the invention are set forth in the dependent claims.

The invention will now be described in more detail by way of a working example with reference to the accompanying drawings, in which

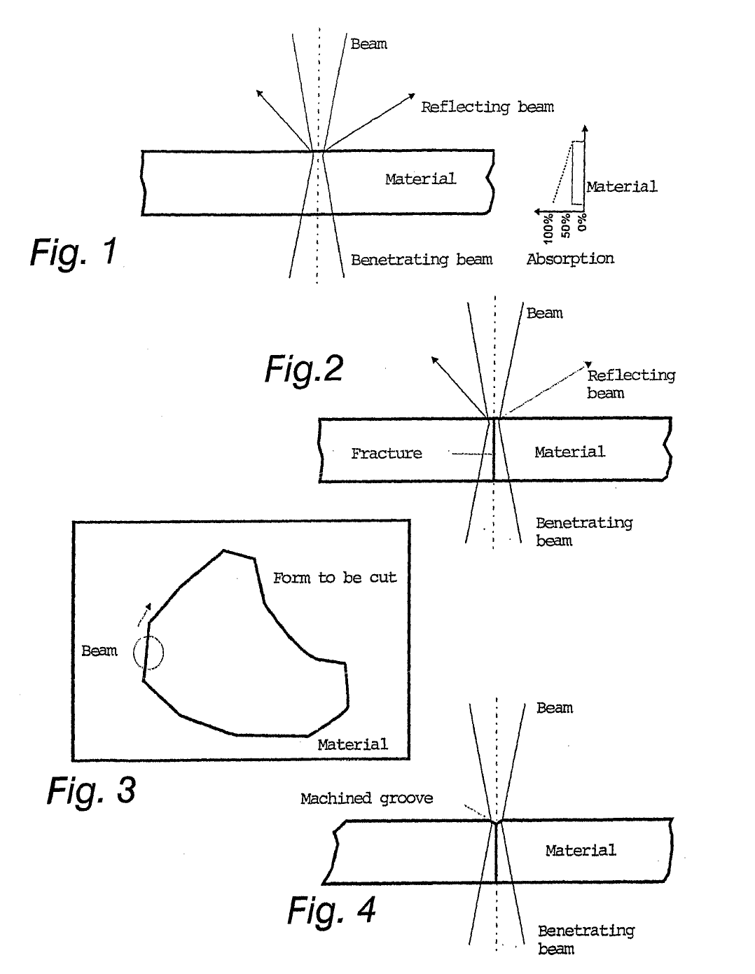

FIG. 1 shows the focusing of a working beam on a material, the little graph showing the absorption of energy in the material.

FIG. 2 shows the status of FIG. 1 with the addition that radiation energy develops a fracture in the material.

FIG. 3 shows a desired machining path from above a workpiece to be cut, along which the beam is moved, and

FIG. 4 shows the use of a guide groove machined in the surface of a workpiece for controlling a fracture to be “machined” in the material.

Machining is performed by using electromagnetic radiation, a typical example of which is laser light. The radiation has a specific wavelength which is selected according to a material to be machined, such that the radiation penetrates inside the material without substantial surface absorption. As the material-specifically selected beam is also focused inside a material, the result is a stress condition which breaks up the material in a controlled manner. The focusing is effected in a wavelength-specific fashion by an appropriate method. E.g. a laser beam can be focused by means of optics (a lens or a mirror). In some cases, it possible to perform focusing also by means of magnet coils. What is essential is that the focal point of radiation lies within a material and/or in the proximity of a penetration surface in order to produce within the material a sufficiently high power density for the radiation. Thus, a high power density is achieved by focusing a beam e.g. with appropriate optics. The wavelength used for machining must be selected material-specifically, such that no substantial surface absorption takes place but, instead, the absorption coefficient of a material over a selected wavelength results in the absorption of a beam in the material across the entire material thickness. Some of the beam may reflect from the surface of or from within the material to atmosphere and some of the beam may penetrate through the material.

Thus, a method of the invention is based on the use of high-power density electromagnetic radiation in the machining of a material. Novelty of the method is based on the fact that the machined material is transmissive to the wavelength of electromagnetic radiation used for machining, but at the same time the high power density of radiation at a so-called focal point results in the material being cut for two segments (see FIGS. 1 and 2). Some of the energy will be absorbed evenly throughout the material thickness.

The radiation used as shown in FIG. 3 is carried along an imagined working path and the material breaks up in two segments as the beam advances in a controlled manner along the programmed, desired working path.

The method can be applied e.g. for cutting glass by means of laser light behaving like visible light. Electromagnetic radiation is focused into a small dot by means of appropriate equipment, which in the case of laser light comprises typically a lens or a mirror, the energy density rising to such a high level that the material develops a fracture within itself.

FIG. 4 shows a guide groove machined in the surface of a material, which matches the form to be cut and controls the focal point of radiation in its movement or cutting operation according to the form to be cut.

A second way of conducting the method is such that laser radiation is used to produce within a material a stress zone matching a desired form and then the material is subjected to a shear force which breaks apart the segments on opposite sides of the stress zone.

1. A method for machining a material with high-power density electromagnetic radiation, which has its wavelength selected material-specifically, such that the radiation penetrates inside the material without substantial surface absorption and that the radiation is focused on a spot inside the material and/or in the proximity of a penetration surface and this spot is moved along a desired machining path, characterized in that the material is cut for two segments by using one advancing beam of said radiation having its focusing and wavelength selected such that the beam is absorbed in the material across the entire material thickness.

2. A method as set forth in claim 1, characterized in that the electromagnetic radiation is provided by laser light and the focusing is effected by means of optics.

3. A method as set forth in claim 1, characterized in that the method is used for cutting glass.

4. A method as set forth in claim 1, characterized in that the surface of a material is machined for a guide groove which matches the form to be cut and controls the movement of a radiation focus.

5. A method as set forth in claim 1, characterized in that the beam of laser radiation is used to develop inside the material a stress zone of a desired shape and this is followed by subjecting the material to a shear force capable of breaking apart the segments present on opposite sides of the stress zone.
